(19) United States
(12) Patent Application Publication
(10) Pub. No.: US 2024/0004275 A1
(43) Pub. Date: Jan. 4, 2024

(54) LIGHT SOURCE DEVICE AND DISPLAY APPARATUS

(71) Applicants: Jun MASHIMO, Kanagawa (JP); Tomoya FUJII, Kanagawa (JP); Mayu BANNO, Kanagawa (JP)

(72) Inventors: Jun MASHIMO, Kanagawa (JP); Tomoya FUJII, Kanagawa (JP); Mayu BANNO, Kanagawa (JP)

(73) Assignee: Ricoh Company, Ltd., Tokyo (JP)

(21) Appl. No.: 18/331,525

(22) Filed: Jun. 8, 2023

(30) Foreign Application Priority Data
Jun. 30, 2022 (JP) 2022-106679

(51) Int. Cl. G03B 21/16; G03B 21/20; G03B 21/14

(52) U.S. Cl. CPC G03B 21/16; G03B 21/204; G03B 21/145; G03B 21/2066

(57) ABSTRACT

A light source device includes: a light source to emit an excitation light beam having a first wavelength; a heat generation member to convert the first wavelength of the excitation light beam emitted from the light source into a light beam having a second wavelength different from the first wavelength; a substrate to which the heat generation member is attached; a motor to rotate the substrate; a bracket to hold the motor; a casing having an opening penetrating through the casing; and a cooling member connected to the bracket. The casing accommodates the light source, the heat generation member, the substrate, and the bracket. The cooling member cools the heat generation member via the bracket; and seals the opening.

### CROSS-REFERENCE TO RELATED APPLICATIONS

This patent application is based on and claims priority pursuant to 35 U.S.C. § 119(a) to Japanese Patent Application No. 2022-106679, filed on Jun. 30, 2022, in the Japan Patent Office, the entire disclosure of which is hereby incorporated by reference herein.

### BACKGROUND

### Technical Field

The present disclosure relates to a light source device and a display apparatus.

### Related Art

A display apparatus including a light source device to emit an excitation light beam and a phosphor to emit a fluorescent light beam by irradiation of the excitation light beam in a sealed casing has been widely known. In such a display apparatus, temperature inside the casing is less likely to decrease because of the sealed casing.

The illuminance of the light beam emitted from the light source device depends on the amount of fluorescent light beam emitted from the phosphor. The phosphor generates heat by irradiation of the light beam emitted from the light source device. When the phosphor generates heat, the light emission efficiency of the phosphor decreases. Thus, the heat generation of the phosphor in the sealed casing is reduced.

### SUMMARY

A light source device includes: a light source to emit an excitation light beam having a first wavelength; a heat generation member to convert the first wavelength of the excitation light beam emitted from the light source into a light beam having a second wavelength different from the first wavelength; a substrate to which the heat generation member is attached; a motor to rotate the substrate; a bracket to hold the motor; a casing having an opening penetrating through the casing; and a cooling member connected to the bracket. The casing accommodates the light source, the heat generation member, the substrate, and the bracket. The cooling member cools the heat generation member via the bracket; and seals the opening.

Further, an embodiment of the present disclosure provides a display apparatus including: the light source device described above; an image generation panel to generate an image from a light beam emitted from the light source device; and a projection optical system to project the image.

Further, an embodiment of the present disclosure provides a light source device including: a light source to emit an excitation light beam having a first wavelength; a heat generation member to convert the first wavelength of the excitation light beam emitted from the light source into a light beam having a second wavelength different from the first wavelength; a bracket to hold the heat generation member; a casing having an opening penetrating through the casing; and a cooling member connected to the bracket. The casing accommodates the light source, the heat generation member, and the bracket. The cooling member cools the heat generation member via the bracket; and seals the opening.

Further, an embodiment of the present disclosure provides a light source device including: a light source to emit an excitation light beam having a first wavelength; a heat generation member to convert the first wavelength of the excitation light beam emitted from the light source into a light beam having a second wavelength different from the first wavelength; a bracket having a hole and to hold the heat generation member; a casing having an opening penetrating through the casing; and a cooling member penetrating through the hole and couple to the heat generation member. The casing accommodates the light source, the heat generation member, and the bracket. The cooling member cools the heat generation member; and seals the opening.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram of an internal configuration of a display apparatus according to the present embodiment;

FIG. 2 is a cross-sectional view taken along the line A-A of the display apparatus in FIG. 1 according to the present embodiment;

FIG. 3 is an enlarged view of a portion of a light source device according to a first embodiment;

FIG. 4 is an enlarged view of a portion of the light source device according to a second embodiment;

FIG. 5 is an enlarged view of a portion of the light source device according to a third embodiment;

FIG. 6 is an enlarged view of a portion of a first modification of the light source device according to the first embodiment; and

FIG. 7 is an enlarged view of a portion a second modification of the light source device according to the first embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to the embodiments of the present invention, the dust-proof property can be maintained in an assembly process of a light source device and a display apparatus.

In terms of a light source device and a display apparatus, there is a technique to reduce heat generation from a phosphor by using a fan and a heat exchanger installed inside of a casing and a cooling member, a fan, and a heat sink that are installed outside of the casing and connected to the heat exchanger.

However, in the technique described above, dust may come in the casing through an opening connecting the inside and the outside of the casing of the display apparatus. Thus, in the typical display apparatus, it is difficult to assemble a casing having the opening while maintaining dust-proof property.

A light source device and a display apparatus according to the embodiments are described below with reference to the drawings. The configuration of the embodiments described below and the operation and result (effect) produced by the configuration are only examples and are not limited to the contents described below.

Also, the multiple embodiments described below include similar components. Thus, in the following description, common reference numerals are assigned to the similar components and a duplicate description is omitted. Hereinafter, the ordinal number is used only for distinguishing the parts and members, and does not indicate the order or priority.

### First Embodiment

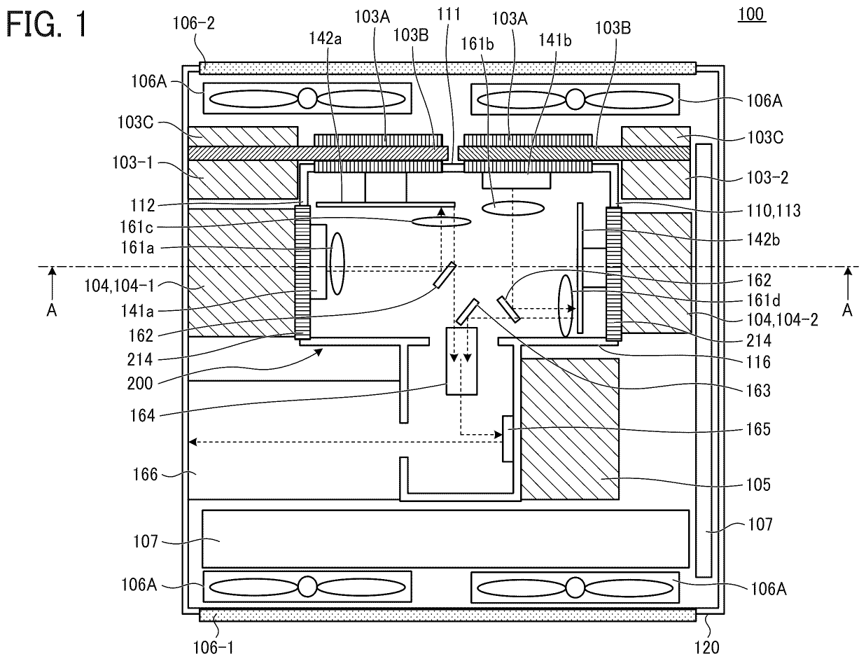

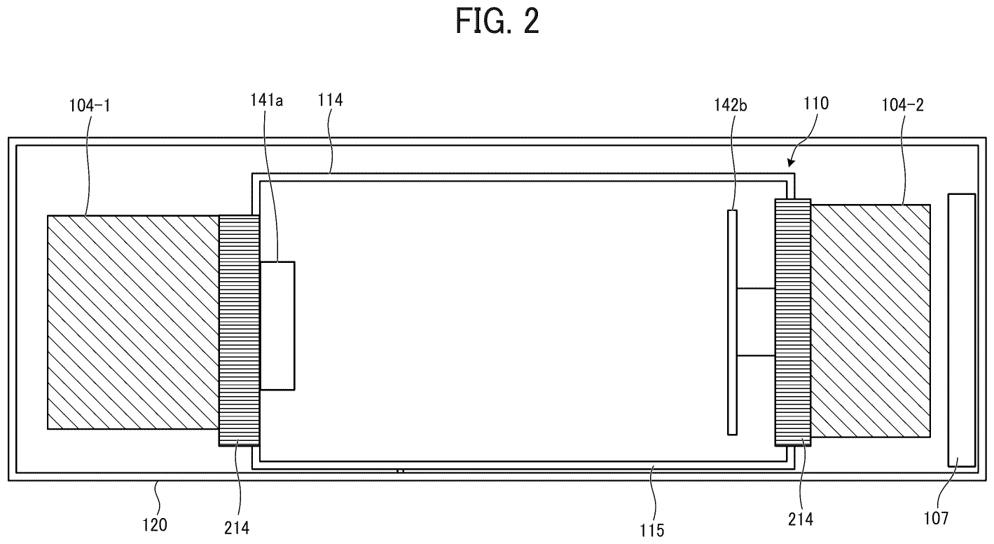

FIG. 1 is a diagram of an internal configuration of a display apparatus 100 according to the present embodiment. FIG. 2 is a cross-sectional view taken along the line A-A of the display apparatus 100 in FIG. 1 according to the present embodiment. As illustrated in FIGS. 1 and 2, the display apparatus 100 according to the present embodiment includes a first light emitter 141a, a second light emitter 141b, a first light reception member 142a, a second light reception member 142b, a first heat dissipation member 103, a second heat dissipation member 104, a third heat dissipation member 105, an intake and exhaust port 106, and an exterior 120. Hereinafter, when the first light emitter 141a and the second light emitter 141b are not distinguished to describe, the first light emitter 141a and the second light emitter 141b are referred to as the light emitter 141. Hereinafter, when the first light reception member 142a and the second light reception member 142b are not distinguished to describe, the first light reception member 142a and the second light reception member 142b are referred to as the light reception member 142.

Among these components, components (i.e., the light emitter 141, the light reception member 142, the first heat dissipation member 103, and the second heat dissipation member 104) attached to a casing 110 (container) are components of the light source device 200. The casing 110 is an example of a casing. The light emitter 141 is an example of a light source.

The casing 110 is installed in an exterior 120 and a member to hold the light emitter 141, the light reception member 142, and optical members such as an optical lens 161 and a mirror 162. In the drawings, some optical components may be omitted or shapes of the optical components may be simplified for the sake of convenience.

The casing 110 has a rectangular parallelepiped shape (i.e., a hexahedron) and has a first surface 111, a second surface 112, a third surface 113, a fourth surface 114, a fifth surface 115, and a sixth surface 116, all of which are rectangular in plan view.

The fourth surface 114 and the fifth surface 115 are opposed to each other. The first surface 111, the second surface 112, the third surface 113, and the sixth surface 116 are installed along four sides of the fourth surface 114 and the fifth surface 115, and are perpendicular to the fourth surface 114 and the fifth surface 115. The first surface 111 and the sixth surface 116 are opposed to each other. The second surface 112 and the third surface 113 are opposed to each other.

The casing 110 is made of, for example, a metal material having high thermal conductivity. Accordingly, the casing 110 can dissipate heat of the light emitter 141 and the light reception member 142 from the surface of the casing 110, and the heat dissipation efficiency of the casing 110 can be increased.

The shape of the casing 110 is not limited to a rectangular parallelepiped shape, and may have other shapes as long as the casing 110 has at least a first surface 111, a second surface 112 substantially perpendicular to the first surface 111, and a third surface 113 substantially perpendicular to the first surface 111 and opposed to the second surface 112. For example, the casing 110 generally has a substantially rectangular parallelepiped shape, but may have a shape in which a part of the rectangular parallelepiped shape is modified.

For example, the casing 110 may have a pentagonal prism shape in which one corner of a rectangular parallelepiped is removed, or a shape in which parts (fourth surface 114 and fifth surface 115) protrudes so as to cover the light reception member 142 larger than the casing 110.

The light emitter 141 is installed in the casing 110 and generates heat at the time of light emission. The light emitter 141 emits an excitation light beam having a predetermined wavelength. Examples of the light emitter 141 includes a laser light source, a laser diode (LD), and a light emitting diode (LED). Typically, a light source has a upper limit of temperature that allows the operation and is cooled below the upper limit temperature. In addition, a light source has a feature in which the light utilization efficiency is decreasing with increasing the temperature. Herein, the light utilization efficiency is a ratio of the energy used for light output to the power consumption.

The light reception member 142 is installed in the casing 110 and generates heat by light irradiation. Examples of the light reception member 142 include a phosphor (fluorescent material) or a color filter. The light reception member 142 includes a base member having a function such as a light converter or a wavelength filter. In such a case, the base member may be a rotatable member or a still member. The base member may also be a light transmission member or a light reflection member.

In the present embodiment, as illustrated in FIGS. 1 and 2, the first light reception member 142a is installed on the first surface 111 of the casing 110, and the second light reception member 142b is installed on the third surface 113 of the casing 110.

The first heat dissipation member 103 is installed at the outside of the casing 110 and dissipates heat generated from mainly the second light emitter 141b and the first light reception member 142a. The first heat dissipation member 103 includes a heat reception plate 103A, a heat transportation member 103B, and a heat dissipation member 103C.

The heat reception plate 103A receives heat from the second light emitter 141b and the first light reception member 142a. The heat transportation member 103b transmits heat from the second light emitter 141b and the first light reception member 142a from the heat reception plate 103A to the heat dissipation member 103C.

The heat transportation member 103B is, for example, a heat pipe. The heat reception plate 103A dissipates heat from the second light emitter 141b and the first light reception member 142a. In the present embodiment, the heat sink having a fin is used as the heat dissipation member 103C to increase an area of heat transfer, but is not limited thereto.

Since the first heat dissipation member 103 includes the heat transportation member 103B, the heat resistance can be reduced as compared with the case where a heat sink only having heat conduction is used. As a result, the cooling efficiency can be increased. Preferably, each of members of the first heat dissipating member 103 is connected by a member having a thermal conductivity larger than conductivity of air, for example thermal paste, thermal sheet, or metal brazing.

In the present embodiment, the display apparatus 100 includes two first heat dissipation members 103 (the first heat dissipation member 103-1 and the first heat dissipation member 103-2). In the present embodiment, as illustrated in FIG. 1, the heat reception plate 103A of the first heat dissipation member 103-1 and the heat reception plate 103A of the first heat dissipation member 103-2 are installed on the first surface 111 of the casing 110.

The second heat dissipation member 104 is installed at the outside of the casing 110 and dissipates heat generated from mainly the first light emitter 141a and the second light reception member 142b. In the present embodiment, the heat sink having a fin is used as the second heat dissipation member 104 to increase an area of heat transfer, but is not limited thereto. The shape of the fin may be at least one having unevenness, and the fin includes plate fins, pin fins, or corrugated fins.

In the present embodiment, as illustrated in FIGS. 1 and 2, the one second heat dissipation member 104-1 is installed on the second surface 112 of the casing 110, and the other second heat dissipation member 104-2 is installed on the third surface 113 of the casing 110.

Accordingly, in the present embodiment, since the light reception member 102 can be thermally connected to the second heat dissipation member 104 via the second surface 112 of the casing 110 and the third surface 113 of the casing 110, heat of the first light emitter 141a and the second light reception member 142b can efficiently be dissipated from the second heat dissipation member 104 via the heat path having only heat conduction.

The third heat dissipation member 105 is installed on the back side of the image generation panel 165 so as to be thermally connected to the image generation panel 165 and mainly dissipates heat of the image generation panel 165. Examples of the third heat dissipation member 105 include a heat sink, a heat pipe module, a liquid cooling member, or a Peltier element.

The intake and exhaust port 106 takes outside air into the exterior 120 of the display apparatus 100, transfers heat from the first heat dissipation member 103 and the second heat dissipation member 104 to the outside air, and exhausts the outside air having high temperature to the outside of the exterior 120 so to dissipate heat in the exterior 120. Preferably, the intake and exhaust port 106 are installed at two or more positions.

In the present embodiment, as illustrated in FIG. 1, the intake and exhaust port 106-2 is installed on one surface of the exterior 120, and the intake and exhaust port 106-1 is installed on the other surface of the exterior 120 that is opposite side of the one surface. Each of the intake and exhaust ports 106 includes an air flow generation member 106A.

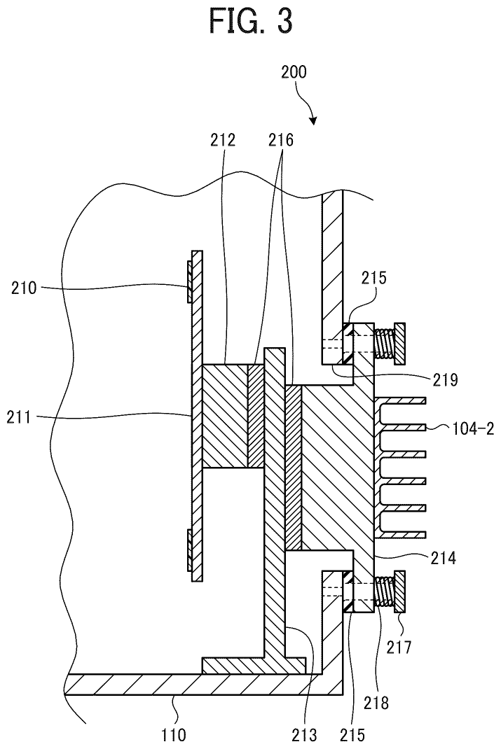

FIG. 3 is an enlarged view of a portion of the light source device 200 according to the first embodiment. As illustrated in FIG. 3, the light source device 200 includes a wavelength converter 210, a substrate 211, a motor 212, a bracket 213, a heat reception plate 214, an elastic member 215, multiple heat conduction members 216, a stepped screw 217, and a spring 218. The wavelength converter 210 is an example of the heat generation member. The heat reception plate 214 is an example of the cooling member. The stepped screw 217 is an example of a screw. The cooling opening 219 is an example the opening.

In some embodiments, a light source device includes: a light source to emit an excitation light beam having a first wavelength; a heat generation member to convert the first wavelength of the excitation light beam emitted from the light source into a light beam having a second wavelength different from the first wavelength; a substrate to which the heat generation member is attached; a motor to rotate the substrate; a bracket to hold the motor; a casing having an opening penetrating through the casing; and a cooling member connected to the bracket. The casing accommodates the light source, the heat generation member, the substrate, and the bracket. The cooling member cools the heat generation member via the bracket; and seals the opening.

The casing 110 of the light source device 200 houses the first light emitter 141a, the second light emitter 141b, the wavelength converter 210, the substrate 211, the motor 212, and the bracket 213. Further, the casing 110 has a cooling opening 219.

The wavelength converter 210 is a member to convert a predetermined wavelength of an excitation light beam emitted from the light emitter 141 into a different wavelength. The wavelength converter 210 is a portion of the light reception member 142 and is coated or attached on the substrate 211. In other words, the light reception member 142 includes the wavelength converter 210 and the substrate 211. The substrate 211 is, for example, a disk such as a phosphor wheel. However, the shape of the substrate 211 is not limited to a disk shape.

The motor 212 is held by the bracket 213 via the heat conduction member 216 and attaches the substrate 211. Accordingly, the motor 212 enables the substrate 211 to rotate. The bracket 213 is fixed to the casing 110 by, for example, a screw and attaches multiple heat conduction members 216. The bracket 213 holds the motor 212 via the heat conduction member 216.

The heat reception plate 214 is made of, for example, a metal material having high thermal conductivity. The heat reception plate 214 touches the bracket 213 through the cooling opening 219 from the outside of the casing 110 via heat conduction member 216. In other words, the bracket 213 touches the heat reception plate 214 that penetrates cooling opening 219. The heat reception plate 214 attaches the second heat dissipation member 104-2. Accordingly, the heat reception plate 214 can cool the heat of the wavelength converter 210 and the substrate 211 via the bracket 213.

The elastic member 215 is made of, for example, a synthetic resin that is elastically deformable (i.e., having an elastic deformation property). The elastic member 215 is disposed between the casing 110 and the heat reception plate 214 and surrounds the cooling opening 219.

The multiple heat conduction members 216 is made of, for example, a metal material having high thermal conductivity. Each of the multiple heat conduction members 216 is disposed between the motor 212 and the bracket 213 and between the bracket 213 and the heat reception plate 214.

In some embodiments, the light source device further includes a heat conduction member between the bracket and the cooling member.

In some embodiments, the light source device further includes a heat conduction member between the motor and the bracket.

The stepped screw 217 penetrates a portion of the heat reception plate 214, the elastic member 215, and a portion of the casing 110 from the outside of the casing 110, and extends toward the inside of the casing 110. The stepped screw 217 fixes the heat reception plate 214 and the elastic member 215 to the casing 110. The spring 218 is wound around a stepped screw 217.

In some embodiments, the light source device further includes: an elastic member between the casing and the cooling member; and a screw fixing the bracket and the cooling member.

In some embodiments, the light source device further includes: an elastic member between the casing and the cooling member; and a screw fixing the casing and the cooling member.

In some embodiments, in the light source device, the screw penetrates the casing, the elastic member, and the cooling member to fix the cooling member to the casing.

The cooling opening 219 is a hole opened on the side surface of the casing 110 to connect the outside and the inside of the casing 110. The position at which the cooling opening 219 opens is a position at which the heat reception plate 214 can touch the bracket 213 from the outside of the casing 110. The size of the cooling opening 219 is such that a portion of the heat reception plate 214 can pass through the cooling opening 219. In the present embodiment, the cooling opening 219 opens on the side surface of the casing 110. However, the position at which the cooling opening 219 opens may be appropriately changed in accordance with the arrangement of each component of the light source device 200.

An optical path in the display apparatus 100 according to the present embodiment described above will be described. Herein, as an example, a case where a blue laser light source is used for the light emitter 141 will be described.

As illustrated in FIG. 1, for example, the blue laser light beams emitted from the first light emitter 141a and the second light emitter 141b are condensed by the optical lenses 161a and 161b. The light beams condensed by the optical lenses 161a and 161b reach the mirror 162.

The mirror 162 reflects a light beam having a wavelength of a blue color and transmits a light beam having a wavelength longer than a green color. The light beam reflected by the mirror 162 is condensed and propagates to the wavelength converter 210 coated or attached on the substrate 211 rotated by the motor 212. The wavelength convert 210 is irradiated with the light beam.

When the wavelength converter 210 is excited by the blue laser light beam, the wavelength converter 210 emits a yellow fluorescent light beam. The display apparatus 100 has an optical path of the first light emitter 141a and the first light reception member 142a and an optical path of the second light emitter 141b and the second light reception member 142b. The two fluorescent light beams generated by the two optical paths described above are combined by the combination prism 163 and enter the light tunnel 164.

The light beam incident on the light tunnel 164 is reflected multiple times by the inner surface of the light tunnel 164 so that the illuminance distribution of the light beam at the exit of the light tunnel 164 is homogenized. The light beam emitted from the light tunnel 164 enters the image generation panel 165. Accordingly, an image is generated by the image generation panel 165, and the image is projected from the projection optical system 166.

In some embodiments a display apparatus includes: the light source device according to any one of the first aspect to the tenth aspect, an image generation panel to generate an image from a light beam emitted from the light source device; and a projection optical system to project the image.

An air flow path in the display apparatus 100 according to the embodiment will be described.

In the display apparatus 100 according to the present embodiment, for example, when the intake and exhaust port 106-1 takes air, and the intake and exhaust port 106-2 exhausts the air, the air taken by the air flow generation member 106A from the intake and exhaust port 106-1 cools an electronic substrate 107, the projection optical system 166, a second heat dissipation member 104-1, and a first heat dissipation member 103 in this order, and is exhausted from the intake and exhaust port 106-2 by the air flow generation member 106A.

By contrast, the air taken in the air flow generation member 106A from the intake and exhaust port 106-1 cools the electronic substrate 107, the third heat dissipation member 105, the second heat dissipation member 104-2, and the first heat dissipation member 103-2 in this order, and is exhausted from the intake and exhaust port 106-2 by the air flow generation member 106A.

In a configuration of the display apparatus 100, the intake and exhaust port 106-2 may take air, and the intake and exhaust port 106-1 may exhaust the air. In such a case, the direction of the air flow path in the display apparatus 100 is opposite to the direction of the air flow path described above.

Cooling operation on the wavelength converter 210 in the display apparatus 100 according to the present embodiment will be described.

Among the series of operation described above, the light beam reflected by the mirror 162 reaches the first light reception member 142a and the second light reception member 142b, and the first light reception member 142a and the second light reception member 142b generate heat by the light beam irradiation so that the temperature inside of the casing 110 of the light source device 200 rises.

As illustrated in FIG. 3, the heat conduction member 216 between the motor 212 and the bracket 213 and between bracket 213 and the heat reception plate 214 conducts heat from the heat reception plate 214 to the heat reception plate 214 via the bracket 213. A portion of the heat reception plate 214 is exposed to the outside of the casing 110 through the cooling opening 219 and attaches the second heat dissipation member 104-2. Accordingly, in the light source device 200, contact heat resistance of each component in the casing 110 is reduced, and the cooling efficiency is increased.

The cooling openings 219 is surrounded by the elastic member 215. A portion of the heat reception plate 214 closes the cooling opening 219 with the stepped screw 217 and connects with the casing 110. In other words, the casing 110 is sealed by the heat reception plate 214, the elastic member 215 and the stepped screw 217.

For example, when assembling the display apparatus 100 and the light source device 200, an operator passes the heat reception plate 214 through the cooling opening 219, brings the heat reception plate 214 into contact with the bracket 213 fixed to the casing 110, and fixes the heat reception plate 214 with the stepped screw 217.

According to the configuration described above, the operator can assemble the display apparatus 100 and the light source device 200 while closing the cooling opening 219 with the heat reception plate 214. Accordingly, the heat reception plate 214 prevents dust from entering the inside through the cooling opening 219 while assembling the display apparatus 100 and the light source device 200. Thus, the display apparatus 100 and the light source device 200 according to the present embodiment can maintain the dust-proof property in assembling.

### Second Embodiment

The second embodiment will be described.

The second embodiment differs from the first embodiment in that the wavelength converter 210 is held by the plate spring 220 with respect to the bracket 213. In the following description of the second embodiment, the description of the same configurations as in the first embodiment will be omitted, and those different from the first embodiment will be described.

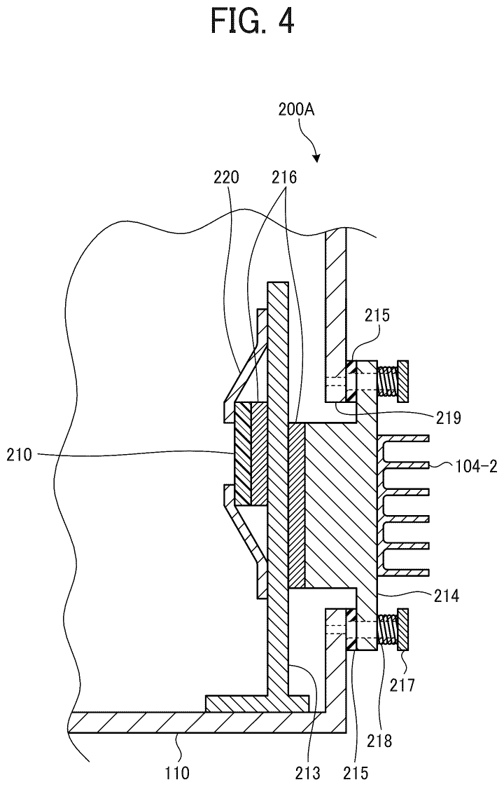

FIG. 4 is an enlarged view of a portion of the light source device 200 according to the second embodiment. In the first embodiment, the wavelength converter 210 is coated on the substrate 211, and the bracket 213 holds the motor 212 that rotates the substrate 211.

As illustrated in FIG. 4, the light source device 200A according to the second embodiment, the wavelength converter 210 is pressed by the plate spring 220 to the bracket. In other words, the bracket 213 holds the wavelength converter 210 by the plate spring 220. In addition, the heat conduction member 216 is disposed between the wavelength converter and the bracket 213. According to such a configuration, even when the light reception member 142 is, for example, a stationary member instead of a rotation member, the same effect as the first embodiment can be obtained.

In some embodiments, a light source device includes: a light source to emit an excitation light beam having a first wavelength; a heat generation member to convert the first wavelength of the excitation light beam emitted from the light source into a light beam having a second wavelength different from the first wavelength; a bracket to hold the heat generation member; a casing having an opening penetrating through the casing; and a cooling member connected to the bracket. The casing accommodates the light source, the heat generation member, and the bracket. The cooling member cools the heat generation member via the bracket; and seals the opening.

In some embodiments, the light source device further includes a heat conduction member between the heat generation member and the bracket.

### Third Embodiment

The third embodiment will be described.

The third embodiment differs from the second embodiment in that an opening 221 is installed a portion of the bracket 213. In the following description of the third embodiment, the description of the same configurations as in the first embodiment and the second embodiment will be omitted, and those different from the first embodiment and the second embodiment will be described.

In some embodiments, a light source device includes: a light source to emit an excitation light beam having a first wavelength; a heat generation member to convert the first wavelength of the excitation light beam emitted from the light source into a light beam having a second wavelength different from the first wavelength; a bracket having a hole and to hold the heat generation member; a casing having an opening penetrating through the casing; and a cooling member penetrating through the hole and couple to the heat generation member. The casing accommodates the light source, the heat generation member, and the bracket. The cooling member cools the heat generation member; and seals the opening.

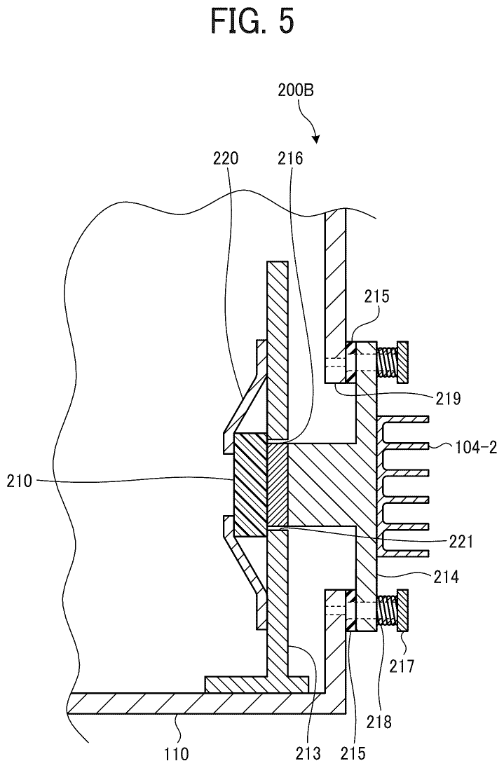

FIG. 5 is an enlarged view of a portion of the light source device 200B according to the third embodiment. In the second embodiment, the wavelength converter 210 is held by the plate spring 220 to the bracket 213 via the heat conduction member 216. As illustrated in FIG. 5, the light source device 200B according to the third embodiment, the bracket 213 has the opening 221. The size of the opening 221 has a size that allows a portion of the heat reception plate 214 and the heat conduction member 216 to pass through and is smaller than the size of the wavelength converter 210.

The wavelength converter 210 comes into contact with the heat reception plate 214 that penetrates the cooling opening 219 and the opening 221. The bracket 213 holds the wavelength converter 210 with the plate spring 220 and the heat reception plate 214 that penetrates the cooling opening 219 and the opening 221. The heat conduction member 216 is disposed in the opening 221 and between the wavelength converter 210 and the heat reception plate 214.

In some embodiments, the light source device further includes a heat conduction member between the heat generation member and the cooling member.

According to such a configuration, the same effect as the first embodiment described above is obtained even when the heat reception plate 214 does not come contact with the bracket 213 via the heat conduction member 216. Further, in the light source device 200B according to the third embodiment as compared with the light source devices 200 and 200A according to the first and second embodiments, the volume of the bracket 213 and the volume of the heat reception plate 214 are reduced, so that the weight can be reduced.

### First Modification of the First Embodiment

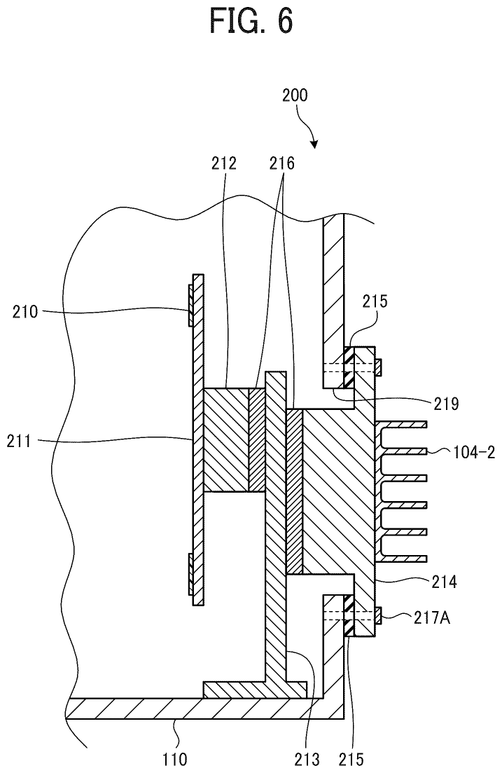

In the first embodiment, the heat reception plate 214 is fixed to the casing 110 by the stepped screw 217, however the component for fixing the heat reception plate 214 to the casing 110 is not limited thereto. FIG. 6 is an enlarged view of a portion of a first modification of the light source device 200 according to the first embodiment.

The stepped screw 217 penetrates a portion of the heat reception plate 214, the elastic member 215, and a portion of the casing 110 from the outside of the casing 110 and extends toward the inside of the casing 110. The stepped screw 217 fixes the heat reception plate 214 and the elastic member 215 to the casing 110. Accordingly, the casing 110 can also be sealed by the screw 217A. The screw 217A is also an example of a screw. Further, the configuration of the first modification is also applicable to the second and third embodiments described above.

### Second Modification of the First Embodiment

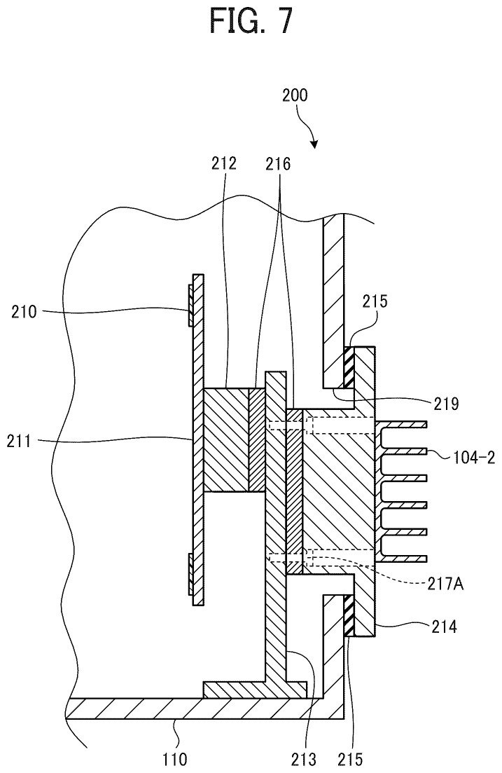

In the first modification according to the first embodiment, the screw 217A penetrates a portion of the heat reception plate 214, the elastic member 215, and a portion of the casing 110 to fix the portion of the heat reception plate 214 to the casing 110. However, the position of the screw 217A in the configuration is not limited to thereto. FIG. 7 is an enlarged view of a portion of a second modification of the light source device 200 according to the first embodiment.

As illustrated in FIG. 7, the screw 217A penetrates a portion of the heat reception plate 214, the heat conduction member 216, and a portion of the bracket 213 from the outside of the casing 110 and extends toward the inside of the casing 110. The stepped screw 217 fixes the bracket 213, the heat reception plate 214 and the elastic member 215 to the casing 110. Accordingly, the casing 110 can also be sealed by fixing the bracket 213 and the heat reception plate 214 with the screw 217A. Further, the configuration of the second modification is also applicable to the second embodiment described above.

The embodiments described above are described as examples and does not intend to limit the disclosure to the precise form disclosed. The embodiments described above can be implemented in other various forms, and various combinations, omissions, replacements, changes, and the like can be made without departing from the scope of the invention. Specifications such as configuration, shape, or the like (structure, type, direction, type, size, length, width, thickness, height, number, arrangement, position, material, or the like.) can be appropriately changed and implemented.

Aspects of the present invention is as follows, for example.

In a first aspect, a light source device includes: a light source to emit an excitation light beam having a first wavelength; a heat generation member to convert the first wavelength of the excitation light beam emitted from the light source into a light beam having a second wavelength different from the first wavelength; a substrate to which the heat generation member is attached; a motor to rotate the substrate; a bracket to hold the motor; a casing having an opening penetrating through the casing; and a cooling member connected to the bracket. The casing accommodates the light source, the heat generation member, the substrate, and the bracket. The cooling member cools the heat generation member via the bracket; and seals the opening.

In a second aspect, the light source device according to the first aspect, further includes: an elastic member between the casing and the cooling member; and a screw fixing the bracket and the cooling member.

In a third aspect, the light source device according to the first aspect or the second aspect further includes: an elastic member between the casing and the cooling member; and a screw fixing the casing and the cooling member.

In a fourth aspect, in the light source device according to any one of the second aspect or the third aspect, the screw penetrates the casing, the elastic member, and the cooling member to fix the cooling member to the casing.

In a fifth aspect, the light source device according to any one of the first aspect to the fourth aspect further includes a heat conduction member between the bracket and the cooling member.

In a sixth aspect, the light source device according to any one of the first aspect to the fifth aspect further includes a heat conduction member between the motor and the bracket.

In a seventh aspect, a light source device including: a light source to emit an excitation light beam having a first wavelength; a heat generation member to convert the first wavelength of the excitation light beam emitted from the light source into a light beam having a second wavelength different from the first wavelength; a bracket to hold the heat generation member; a casing having an opening penetrating through the casing; and a cooling member connected to the bracket. The casing accommodates the light source, the heat generation member, and the bracket. The cooling member cools the heat generation member via the bracket; and seals the opening.

In an eight aspect, the light source device according to the seventh aspect further includes a heat conduction member between the heat generation member and the bracket.

In a ninth aspect, a light source device includes: a light source to emit an excitation light beam having a first wavelength; a heat generation member to convert the first wavelength of the excitation light beam emitted from the light source into a light beam having a second wavelength different from the first wavelength; a bracket having a hole and to hold the heat generation member; a casing having an opening penetrating through the casing; and a cooling member penetrating through the hole and couple to the heat generation member. The casing accommodates the light source, the heat generation member, and the bracket. The cooling member cools the heat generation member; and seals the opening.

In a tenth aspect, the light source device according to the ninth aspect further includes a heat conduction member between the heat generation member and the cooling member.

In an eleventh aspect, a display apparatus includes: the light source device according to any one of the first aspect to the tenth aspect, an image generation panel to generate an image from a light beam emitted from the light source device; and a projection optical system to project the image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A light source device comprising:
a light source configured to emit an excitation light beam having a first wavelength;
a heat generation member configured to convert the first wavelength of the excitation light beam emitted from the light source into a light beam having a second wavelength different from the first wavelength;
a substrate to which the heat generation member is attached;
a motor configured to rotate the substrate;
a bracket configured to hold the motor;
a casing having an opening penetrating through the casing, the casing accommodating the light source, the heat generation member, the substrate, and the bracket; and
a cooling member connected to the bracket, the cooling member configured to:
cool the heat generation member via the bracket; and
seal the opening.

2. The light source device according to claim 1, further comprising:
an elastic member between the casing and the cooling member; and
a screw fixing the bracket and the cooling member.

3. The light source device according to claim 1, further comprising:
an elastic member between the casing and the cooling member; and
a screw fixing the casing and the cooling member.

4. The light source device according to claim 3,
wherein the screw penetrates the casing, the elastic member, and the cooling member to fix the cooling member to the casing.

5. The light source device according to claim 1, further comprising a heat conduction member between the bracket and the cooling member.

6. The light source device according to claim 1, further comprising a heat conduction member between the motor and the bracket.

7. A display apparatus comprising:
the light source device according to claim 1;
an image generation panel configured to generate an image from a light beam emitted from the light source device; and
a projection optical system configured to project the image.

8. A light source device comprising:
a light source configured to emit an excitation light beam having a first wavelength;
a heat generation member configured to convert the first wavelength of the excitation light beam emitted from the light source into a light beam having a second wavelength different from the first wavelength;
a bracket configured to hold the heat generation member;
a casing having an opening penetrating through the casing, the casing accommodating the light source, the heat generation member, and the bracket; and
a cooling member connected to the bracket, the cooling member configured to:
cool the heat generation member via the bracket; and
seal the opening.

9. The light source device according to claim 8, further comprising a heat conduction member between the heat generation member and the bracket.

10. A light source device comprising:
a light source configured to emit an excitation light beam having a first wavelength;
a heat generation member configured to convert the first wavelength of the excitation light beam emitted from the light source into a light beam having a second wavelength different from the first wavelength;
a bracket having a hole and configured to hold the heat generation member;
a casing having an opening penetrating through the casing, the casing accommodating the light source, the heat generation member, and the bracket; and
a cooling member penetrating through the hole and couple to the heat generation member, the cooling member configured to:
cool the heat generation member; and
seal the opening.

11. The light source device according to claim 10, further comprising a heat conduction member between the heat generation member and the cooling member.
